(19) United States
(12) Patent Application Publication
(10) Pub. No.: US 2019/0147508 A1
(43) Pub. Date: May 16, 2019

(54) PLATFORM SYSTEM AND METHOD

(71) Applicant: Nuance Communications, Inc., Burlington, MA (US)

(72) Inventors: Raghu Vemula, Salem, NH (US); Arman Sharafshahi, Atlanta, GA (US); Vernon J. Adams, Sandy Springs, GA (US)

(21) Appl. No.: 15/813,856

(22) Filed: Nov. 15, 2017

(51) Int. Cl. G06Q 30/02; G06N 3/08; H04L 29/08

(52) U.S. Cl. CPC G06Q 30/0282; G06T 2207/30004; H04L 67/12; G06N 3/08

(57) ABSTRACT

A computer-implemented method, computer program product and computing system for enabling an online platform. A plurality of computer-based medical diagnostic services are offered within the online platform. A user of the online platform is enabled to select at least one of the plurality of computer-based medical diagnostic services, thus defining at least one selected medical diagnostic service. Clinical content of the user is processed with the at least one selected medical diagnostic service.

### TECHNICAL FIELD

This disclosure relates to platform systems and methods and, more particularly, to platform systems and methods that allow for the offering of services in assisting medical diagnostics.

### BACKGROUND

Recent advances in the fields of artificial intelligence and machine learning are showing promising outcomes in the analysis of clinical content, examples of which may include medical imagery. Accordingly, processes and algorithms are constantly being developed that may aid in the processing and analysis of such medical imagery. Unfortunately, “one-stop-shopping” for such processes and algorithms is difficult at best. For example, these individual processes and algorithms may need to be researched and obtained from disparate sources/websites/companies and the ability to perform said-by-side comparison of such processes and algorithms may be compromised.

### SUMMARY OF DISCLOSURE

In one implementation, a computer-implemented method is executed on a computing device and includes enabling an online platform. A plurality of computer-based medical diagnostic services are offered within the online platform. A user of the online platform is enabled to select at least one of the plurality of computer-based medical diagnostic services, thus defining at least one selected medical diagnostic service. Clinical content of the user is processed with the at least one selected medical diagnostic service.

One or more of the following features may be included. The clinical content may include medical imagery. The plurality of computer-based medical diagnostic services may include one or more machine-learning algorithms. Enabling a user of the online platform to select at least one of the plurality of computer-based medical diagnostic services may include enabling a user of the online platform to subscribe to at least one of the plurality of computer-based medical diagnostic services. User feedback may be received from the user concerning the at least one selected medical diagnostic service. The user feedback may be provided to a producer of the at least one selected medical diagnostic service for quality assurance/control purposes. An identified medical diagnostic service, chosen from the plurality of computer-based medical diagnostic services, may be provided to a third party reviewer. A rating of the identified medical diagnostic service may be received from the third party reviewer. The rating may be based, at least in part, upon a plurality of discrete reviews concerning the identified medical diagnostic service received by the third party reviewer from discrete reviewers. The rating of the identified medical diagnostic service from the third party reviewer may be posted on the online platform.

In another implementation, a computer program product resides on a computer readable medium and has a plurality of instructions stored on it. When executed by a processor, the instructions cause the processor to perform operations including enabling an online platform. A plurality of computer-based medical diagnostic services are offered within the online platform. A user of the online platform is enabled to select at least one of the plurality of computer-based medical diagnostic services, thus defining at least one selected medical diagnostic service. Clinical content of the user is processed with the at least one selected medical diagnostic service.

One or more of the following features may be included. The clinical content may include medical imagery. The plurality of computer-based medical diagnostic services may include one or more machine-learning algorithms. Enabling a user of the online platform to select at least one of the plurality of computer-based medical diagnostic services may include enabling a user of the online platform to subscribe to at least one of the plurality of computer-based medical diagnostic services. User feedback may be received from the user concerning the at least one selected medical diagnostic service. The user feedback may be provided to a producer of the at least one selected medical diagnostic service for quality assurance/control purposes. An identified medical diagnostic service, chosen from the plurality of computer-based medical diagnostic services, may be provided to a third party reviewer. A rating of the identified medical diagnostic service may be received from the third party reviewer. The rating may be based, at least in part, upon a plurality of discrete reviews concerning the identified medical diagnostic service received by the third party reviewer from discrete reviewers. The rating of the identified medical diagnostic service from the third party reviewer may be posted on the online platform.

In another implementation, a computing system includes a processor and a memory system configured to perform operations including enabling an online platform. A plurality of computer-based medical diagnostic services are offered within the online platform. A user of the online platform is enabled to select at least one of the plurality of computer-based medical diagnostic services, thus defining at least one selected medical diagnostic service. Clinical content of the user is processed with the at least one selected medical diagnostic service.

One or more of the following features may be included. The clinical content may include medical imagery. The plurality of computer-based medical diagnostic services may include one or more machine-learning algorithms. Enabling a user of the online platform to select at least one of the plurality of computer-based medical diagnostic services may include enabling a user of the online platform to subscribe to at least one of the plurality of computer-based medical diagnostic services. User feedback may be received from the user concerning the at least one selected medical diagnostic service. The user feedback may be provided to a producer of the at least one selected medical diagnostic service for quality assurance/control purposes. An identified medical diagnostic service, chosen from the plurality of computer-based medical diagnostic services, may be provided to a third party reviewer. A rating of the identified medical diagnostic service may be received from the third party reviewer. The rating may be based, at least in part, upon a plurality of discrete reviews concerning the identified medical diagnostic service received by the third party reviewer from discrete reviewers. The rating of the identified medical diagnostic service from the third party reviewer may be posted on the online platform.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an online platform process according to an embodiment of the present disclosure; and

FIG. 2 is a flowchart of the online platform process of FIG. 1 according to an embodiment of the present disclosure.

Like reference symbols in the various drawings indicate like elements.

### DETAILED DESCRIPTION OF THE PREFERRED EMBODIMENTS

System Overview

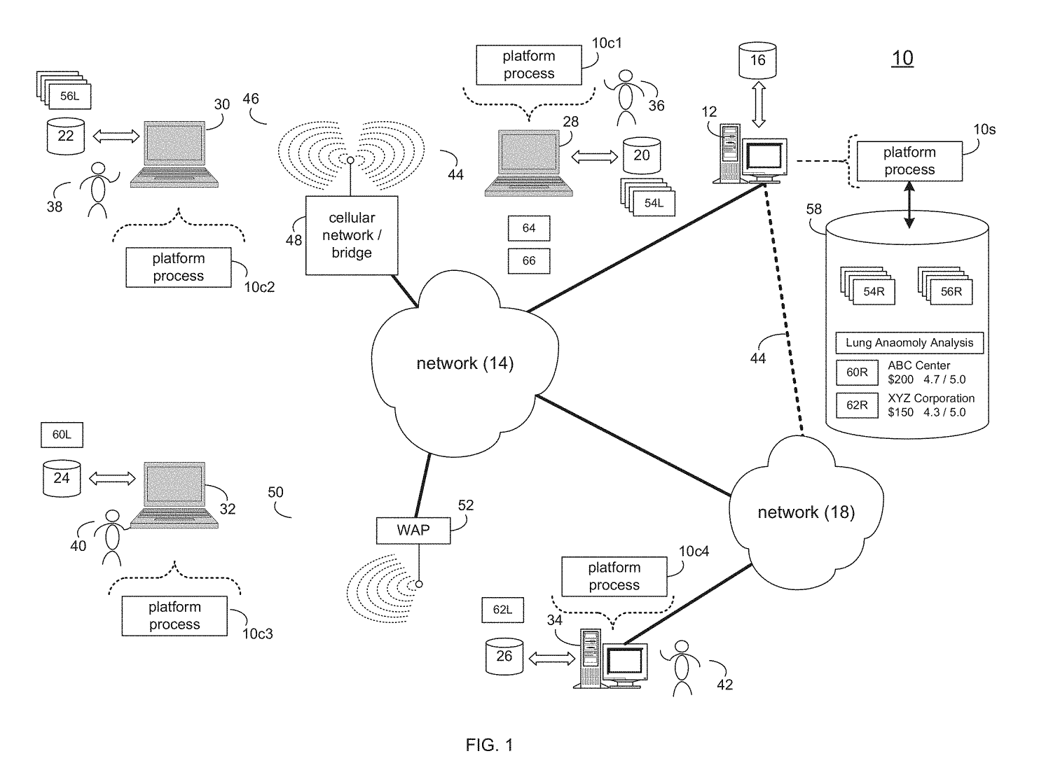

Referring to FIG. 1, there is shown online platform process 10. Online platform process 10 may be implemented as a server-side process, a client-side process, or a hybrid server-side/client-side process. For example, online platform process 10 may be implemented as a purely server-side process via online platform process 10s. Alternatively, online platform process 10 may be implemented as a purely client-side process via one or more of online platform process 10c1, online platform process 10c2, online platform process 10c3, and online platform process 10c4. Alternatively still, online platform process 10 may be implemented as a hybrid server-side/client-side process via online platform process 10s in combination with one or more of online platform process 10c1, online platform process 10c2, online platform process 10c3, and online platform process 10c4. Accordingly, online platform process 10 as used in this disclosure may include any combination of online platform process 10s, online platform process 10c1, online platform process 10c2, online platform process 10c3, and online platform process 10c4. Examples of online platform process 10 may include but are not limited to all or a portion of the PowerShare™ platform and/or the PowerScribe 360 ™ platform available from Nuance Communications™ of Burlington, Mass.

Online platform process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a cloud-based computing platform.

The instruction sets and subroutines of online platform process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of online platform processes 10c1, 10c2, 10c3, 10c4 may include but are not limited to a web browser, a game console user interface, a mobile device user interface, or a specialized application (e.g., an application running on e.g., the Android™ platform, the iOS™ platform, the Windows™ platform, the Linux™ platform or the UNIX™ platform). The instruction sets and subroutines of online platform processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to, a smartphone (not shown), a personal digital assistant (not shown), a tablet computer (not shown), laptop computers 28, 30, 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, iOS™, Linux™, or a custom operating system.

Users 36, 38, 40, 42 may access online platform process 10 directly through network 14 or through secondary network 18. Further, online platform process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, laptop computer 28 and laptop computer 30 are shown wirelessly coupled to network 14 via wireless communication channels 44, 46 (respectively) established between laptop computers 28, 30 (respectively) and cellular network/bridge 48, which is shown directly coupled to network 14. Further, laptop computer 32 is shown wirelessly coupled to network 14 via wireless communication channel 50 established between laptop computer 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between laptop computer 32 and WAP 52. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

While the following discussion concerns medical imagery, this is for illustrative purposes only and is not intended to be a limitation of this disclosure, as other configurations are possible and are considered to be within the scope of this disclosure. For example, the following discussion may concern any type of clinical content (e.g., DNA sequences, EKG results, EEG results, blood panel results, lab results, etc.).

Assume for the following example that users 36, 38 are medical service providers (e.g., radiologists) in two different medical facilities (e.g., hospitals, labs, diagnostic imaging centers, etc.). Accordingly and during the normal operation of these medical facilities, medical imagery may be generated by e.g., x-ray systems (not shown), MRI systems (not shown), CAT systems (not shown), PET systems (not shown) and ultrasound systems (not shown). For example, assume that user 36 generates medical imagery 54L and user 38 generates medical imagery 56L, wherein medical imagery 54L may be stored locally on storage device 20 coupled to laptop computer 28 and medical imagery 56L may be stored locally on storage device 22 coupled to laptop computer 30. When locally storing medical imagery 54L and/or medical imagery 56L, this medical imagery may be stored within e.g., a PACS (i.e., Picture Archiving and Communication System).

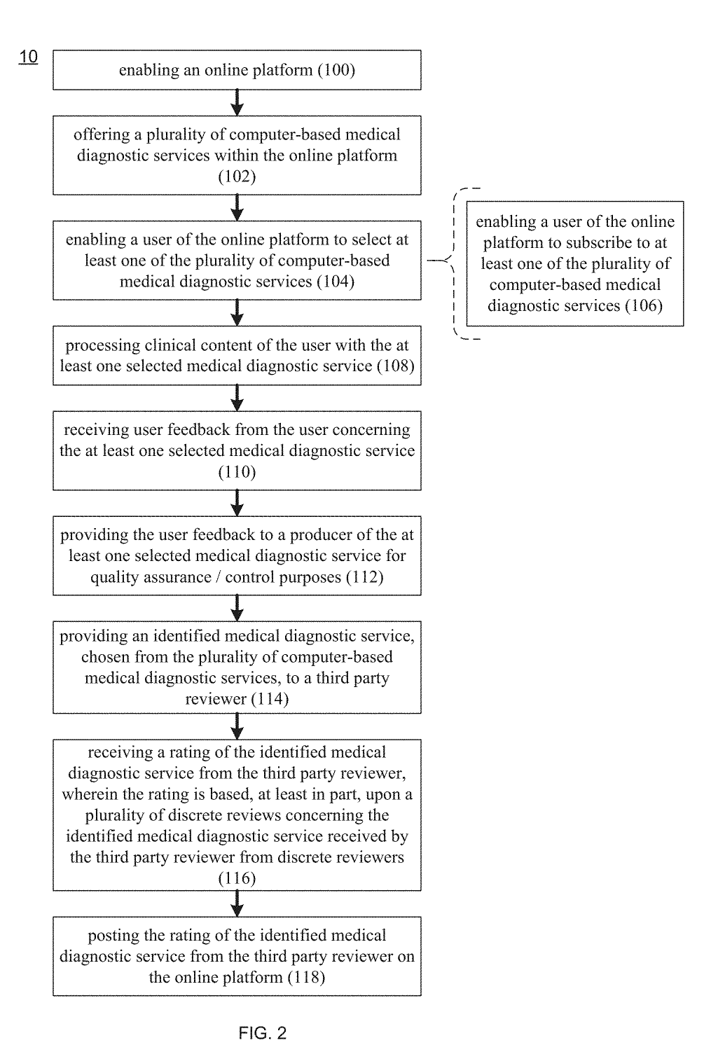

Referring also to FIG. 2, online platform process 10 may enable 100 online platform 58 that may be configured to allow for the sharing of the above-described medical imagery. For example and if user 36 wanted to allow medical imagery 54L to be remotely available, online platform process 10 may store a remote copy of medical imagery 54L (namely medical imagery 54R) within online platform 58. Further and if user 38 wanted to allow medical imagery 56L to be remotely available, online platform process 10 may store a remote copy of medical imagery 56L (namely medical imagery 56R) within online platform 58. Accordingly, if medical imagery 54L concerned a patient of user 36 that wanted to be treated by user 38, a copy of medical imagery 54L (namely medical imagery 54R) may be uploaded to and stored upon online platform 58 so that medical imagery 54R may be accessed by user 38 and/or downloaded to laptop 30 (e.g., to their local PACS).

In addition to allowing for the sharing of medical imagery (e.g., medical imagery 54R and medical imagery 56R), online platform 58 may be configured to allow for the offering of various medical diagnostic services to users (e.g., users 36, 38) of online platform 58.

For the following example, assume that user 40 is a medical research facility (e.g., the ABC Center) that performs cancer research. Assume that user 40 produced a process (e.g., analysis process 60L) that analyzes medical imagery to identify anomalies that may be cancer. Examples of analysis process 60L may include but are not limited to an application or an algorithm that may process medical imagery (e.g., medical imagery 54R and medical imagery 56R), wherein this application/algorithm may utilize artificial intelligence, machine learning and/or probabilistic modeling when analyzing the medical imagery (e.g., medical imagery 54R and medical imagery 56R). Examples of such probabilistic modeling may include but are not limited to discriminative modeling (e.g., a probabilistic model for only the content of interest), generative modeling (e.g., a full probabilistic model of all content), or combinations thereof.

Further assume that user 42 is a medical research corporation (e.g., the XYZ Corporation) that produces applications/algorithms (e.g., analysis process 62L) that analyze medical imagery to identify anomalies that may be cancer. Examples of analysis process 62L may include but are not limited to an application or an algorithm that may process medical imagery (e.g., medical imagery 54R and medical imagery 56R), wherein this application/algorithm may utilize artificial intelligence, machine learning algorithms and/or probabilistic modeling when analyzing the medical imagery (e.g., medical imagery 54R and medical imagery 56R). Examples of such probabilistic modeling may include but are not limited to discriminative modeling (e.g., a probabilistic model for only the content of interest), generative modeling (e.g., a full probabilistic model of all content), or combinations thereof.

Assume for the following example that user 40 (i.e., the ABC Center) wishes to offer analysis process 60L to others (e.g., users 36, 38) so that users 36, 38 may use analysis process 60L to process their medical imagery (e.g., medical imagery 54R and medical imagery 56R, respectively). Further assume that user 42 (i.e., the XYZ Corporation) wishes to offer analysis process 62L to others (e.g., users 36, 38) so that users 36, 38 may use analysis process 62L to process their medical imagery (e.g., medical imagery 54R and medical imagery 56R, respectively).

Accordingly, online platform process 10 and online platform 58 may allow user 40 (i.e., the ABC Center) and/or user 42 (i.e., the XYZ Corporation) to offer analysis process 60L and/or analysis process 62L (respectively) for use by e.g., user 36 and/or user 38. Therefore, online platform process 10 and online platform 58 may be configured to allow user 40 (i.e., the ABC Center) and/or user 42 (i.e., the XYZ Corporation) to upload a remote copy of analysis process 60L and/or analysis process 62L to online platform 58, resulting in analysis process 60R and/or analysis process 62R (respectively) being available for use via online platform 58.

Therefore, online platform process 10 may offer 102 a plurality of computer-based medical diagnostic services (e.g., analysis process 60R, 62R) within the online platform (e.g., online platform 58). For example, online platform process 10 may identify the computer-based medical diagnostic services (e.g., analysis process 60R, 62R) that are available via online platform 58 and may define various criteria for each of the computer-based medical diagnostic services (e.g., analysis process 60R, 62R).

Accordingly and with respect to analysis process 60R, examples of such defined criteria may include but are not limited to: the producer of analysis process 60R (e.g., the ABC Center), the cost of using analysis process 60R (e.g., $200), and a rating for analysis process 60R (e.g., 4.7 out of 5.0). Concerning the cost of using analysis process 60R (e.g., $200), this cost may reflect various criteria, example of which may include but are not limited to: a lifetime license to use analysis process 60R, a monthly subscription fee for using analysis process 60R, and a single use of analysis process 60R for processing a defined batch of medical imagery.

Further and with respect to analysis process 62R, examples of such defined criteria may include but are not limited to: the producer of analysis process 62R (e.g., the XYZ Corporation), the cost of using analysis process 62R (e.g., $150), and a rating for analysis process 62R (e.g., 4.3 out of 5.0). Concerning the cost of using analysis process 62R (e.g., $150), this cost may reflect various criteria, example of which may include but are not limited to: a lifetime license to use analysis process 62R, a monthly subscription fee for using analysis process 62R, and a single use of analysis process 62R for processing a defined batch of medical imagery.

As discussed above, user 36 may generate medical imagery 54L, which may be uploaded (via online platform process 10) to online platform 58 (resulting in medical imagery 54R being available via online platform 58). Online platform process 10 may enable 104 a user (e.g., user 36) of online platform 58 to select at least one of the plurality of computer-based medical diagnostic services (e.g., analysis process 60R, 62R), thus defining at least one selected medical diagnostic service.

As discussed above, the cost of using analysis process 60R and/or analysis process 62R may reflect a monthly subscription fee for using analysis process 60R and/or analysis process 62R. Accordingly and when enabling 104 user 36 of online platform 58 to select at least one of the plurality of computer-based medical diagnostic services (e.g., analysis processes 60R, 62R), online platform process 10 may enable 106 user 36 of online platform 58 to subscribe to (in this example) at least one of the plurality of computer-based medical diagnostic services (e.g., analysis processes 60R, 62R).

Assume for this example that medical imagery 54R includes MRI images of the chest of a patient, wherein user 36 would like to have these images processed by a computer-based medical diagnostic service to determine if there are any anomalies included within medical imagery 54R. As discussed above, analysis process 60R and analysis 62R may be configured to analyze medical imagery to identify anomalies that may be cancer. Accordingly, user 36 may review the various criteria associated with analysis process 60R and analysis process 62R so that user 36 may decide which (if any) of analysis processes 60R, 62R they wish to use.

Assume for this example that user 36 decides to utilize analysis process 60R (e.g., due to its higher rating), thus defining analysis process 60R as the selected medical diagnostic service. Accordingly, user 36 may select analysis process 60R, pay for the same (e.g., via an account that user 36 has established with online platform 58) and may identify the medical imagery (e.g., medical imagery 54R) to be analyzed.

Online platform process 10 may then process 108 clinical content (e.g., medical imagery 54R) of user 36 with the at least one selected medical diagnostic service (e.g., analysis process 60R). As discussed above, analysis process 60R may utilize artificial intelligence, machine learning algorithms and/or probabilistic modeling when analyzing medical imagery 54R. Examples of such probabilistic modeling may include but are not limited to discriminative modeling (e.g., a probabilistic model for only the content of interest), generative modeling (e.g., a full probabilistic model of all content), or combinations thereof.

When the processing 108 of medical imagery 54R is completed, user 36 may be provided with the results. For example, result set 64 may be provided to user 36, wherein result set 64 may identify (e.g., highlight or mark) anomalies within medical imagery 54R, wherein result set 64 may be reviewed by user 36.

Assume that result set 64 identifies twenty potential anomalies within result set 64. Further assume that upon reviewing these twenty potential anomalies, user 36 determines that five of the twenty potential anomalies are false-positives (thus resulting in a 75% accuracy rate). Accordingly, user 36 may generate user feedback (e.g., user feedback 66) concerning result set 64, wherein user feedback 66 may identify the false-positives included within result set 64. Online platform process 10 may receive 110 user feedback 66 from user 36 concerning result set 64 generated for medical imagery 54R, wherein online platform process 10 may provide 112 user feedback 66 to a producer (e.g., ABC Center) of the at least one selected medical diagnostic service (e.g., analysis process 60R) for quality assurance/control purposes. For example, user feedback 66 may specifically identify the false positives included within result set 64. Accordingly the producer (e.g., ABC Center) of analysis process 60R may utilize this information to adjust/revise analysis process 60R (and/or the algorithms utilized therein).

When providing the above-described results (e.g., result set 64) to e.g., user 36, these results may be preprocessed by online platform process 10. While the following discussion concerns one specific manner in which the above-described results (e.g., result set 64) may be preprocessed by online platform process 10, this is for illustrative purposes only and is not intended to be a limitation of this disclosure and is only intended to be illustrative of the manner in which online platform process 10 may preprocess the above-described results (e.g., result set 64).

Accordingly and as one specific example of the manner in which the above-described results (e.g., result set 64) may be utilized in driving clinical decision support systems based on best practices established by healthcare institutions and clinical forums such as American College of Radiology and Fleischner Society, online platform process 10 may automatically insert the results in the decision support rules to generate the appropriate recommendations for the care. For example and with respect to the actual anomalies/findings identified, assume that the anomalies are >2 centimeters. Further, assume that the clinical best practice for anomalies >2 centimeters is to surgically remove the anomalies. Accordingly and with respect to the actual anomalies identified. online platform process 10 may provide result set 64 to user 36 that recommends the surgical removal of the anomalies that are >2 centimeters.

As discussed above and with respect to analysis process 60R, examples of such defined criteria may include a rating for analysis process 60R (e.g., 4.7 out of 5.0). These rating may be generated via third party reviewers. Accordingly, online platform process 10 may have analysis process 60R (or analysis process 62R or any other medical diagnostic service offered via online platform 58) reviewed by such a third party.

For example, online platform process 10 may provide 114 an identified medical diagnostic service (e.g., analysis process 60R), chosen from the plurality of computer-based medical diagnostic services (e.g., analysis processes 60R, 62R) to a third party reviewer. Examples of such a third party reviewer is the American College of Radiology. For example and upon receiving analysis process 60R for review, the third party reviewer (e.g., the American College of Radiology) may provide analysis process 60R to a plurality of trusted entities (e.g., individuals, corporations, organizations, facilities, etc.) for review. This plurality of trusted entities (e.g., individuals, corporations, organizations, facilities, etc.) may each independently review analysis process 60R and provide their discrete reviews to the third party reviewer (e.g., the American College of Radiology). The third party reviewer (e.g., the American College of Radiology) may then consider and compile these discrete reviews and define a rating for analysis process 60R, which may be provided to online platform process 10.

Online platform process 10 may receive 116 a rating (e.g., 4.7 out of 5.0) of the identified medical diagnostic service (e.g., analysis process 60R) from the third party reviewer (e.g., the American College of Radiology), wherein the rating (e.g., 4.7 out of 5.0) may be based, at least in part, upon the plurality of discrete reviews concerning the identified medical diagnostic service (e.g., analysis process 60R) received by the third party reviewer (e.g., the American College of Radiology) from discrete reviewers (e.g., individuals, corporations, organizations, facilities, etc.). Upon receiving 116 the rating (e.g., 4.7 out of 5.0) of analysis process 60R from the American College of Radiology, online platform process 10 may post 118 the rating (e.g., 4.7 out of 5.0) of the identified medical diagnostic service (e.g., analysis process 60R) from the third party reviewer (e.g., the American College of Radiology) on online platform 58.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
enabling an online platform;
offering a plurality of computer-based medical diagnostic services within the online platform;
enabling a user of the online platform to select at least one of the plurality of computer-based medical diagnostic services, thus defining at least one selected medical diagnostic service; and
processing clinical content of the user with the at least one selected medical diagnostic service.

2. The computer-implemented method of claim 1 wherein the clinical content includes medical imagery.

3. The computer-implemented method of claim 1 wherein the plurality of computer-based medical diagnostic services includes one or more machine-learning algorithms.

4. The computer-implemented method of claim 1 wherein enabling a user of the online platform to select at least one of the plurality of computer-based medical diagnostic services includes:
enabling a user of the online platform to subscribe to at least one of the plurality of computer-based medical diagnostic services.

5. The computer-implemented method of claim 1 further comprising:
receiving user feedback from the user concerning the at least one selected medical diagnostic service; and
providing the user feedback to a producer of the at least one selected medical diagnostic service for quality assurance/control purposes.

6. The computer-implemented method of claim 1 further comprising:
providing an identified medical diagnostic service, chosen from the plurality of computer-based medical diagnostic services, to a third party reviewer; and
receiving a rating of the identified medical diagnostic service from the third party reviewer, wherein the rating is based, at least in part, upon a plurality of discrete reviews concerning the identified medical diagnostic service received by the third party reviewer from discrete reviewers.

7. The computer-implemented method of claim 6 further comprising:
posting the rating of the identified medical diagnostic service from the third party reviewer on the online platform.

8. A computer program product residing on a computer readable medium having a plurality of instructions stored thereon which, when executed by a processor, cause the processor to perform operations comprising:
enabling an online platform;
offering a plurality of computer-based medical diagnostic services within the online platform;
enabling a user of the online platform to select at least one of the plurality of computer-based medical diagnostic services, thus defining at least one selected medical diagnostic service; and
processing clinical content of the user with the at least one selected medical diagnostic service.

9. The computer program product of claim 8 wherein the clinical content includes medical imagery.

10. The computer program product of claim 8 wherein the plurality of computer-based medical diagnostic services includes one or more machine-learning algorithms.

11. The computer program product of claim 8 wherein enabling a user of the online platform to select at least one of the plurality of computer-based medical diagnostic services includes:
enabling a user of the online platform to subscribe to at least one of the plurality of computer-based medical diagnostic services.

12. The computer program product of claim 8 further comprising:
receiving user feedback from the user concerning the at least one selected medical diagnostic service; and
providing the user feedback to a producer of the at least one selected medical diagnostic service for quality assurance/control purposes.

13. The computer program product of claim 8 further comprising:
providing an identified medical diagnostic service, chosen from the plurality of computer-based medical diagnostic services, to a third party reviewer; and
receiving a rating of the identified medical diagnostic service from the third party reviewer, wherein the rating is based, at least in part, upon a plurality of discrete reviews concerning the identified medical diagnostic service received by the third party reviewer from discrete reviewers.

14. The computer program product of claim 13 further comprising:
posting the rating of the identified medical diagnostic service from the third party reviewer on the online platform.

15. A computing system including a processor and memory configured to perform operations comprising:
enabling an online platform;
offering a plurality of computer-based medical diagnostic services within the online platform;
enabling a user of the online platform to select at least one of the plurality of computer-based medical diagnostic services, thus defining at least one selected medical diagnostic service; and
processing clinical content of the user with the at least one selected medical diagnostic service.

16. The computing system of claim 15 wherein the clinical content includes medical imagery.

17. The computing system of claim 15 wherein the plurality of computer-based medical diagnostic services includes one or more machine-learning algorithms.

18. The computing system of claim 15 wherein enabling a user of the online platform to select at least one of the plurality of computer-based medical diagnostic services includes:
enabling a user of the online platform to subscribe to at least one of the plurality of computer-based medical diagnostic services.

19. The computing system of claim 15 further configured to perform operations comprising:
receiving user feedback from the user concerning the at least one selected medical diagnostic service; and
providing the user feedback to a producer of the at least one selected medical diagnostic service for quality assurance/control purposes.

20. The computing system of claim 15 further configured to perform operations comprising:
providing an identified medical diagnostic service, chosen from the plurality of computer-based medical diagnostic services, to a third party reviewer; and
receiving a rating of the identified medical diagnostic service from the third party reviewer, wherein the rating is based, at least in part, upon a plurality of discrete reviews concerning the identified medical diagnostic service received by the third party reviewer from discrete reviewers.

21. The computer-implemented method of claim 20 further configured to perform operations comprising:
posting the rating of the identified medical diagnostic service from the third party reviewer on the online platform.
